(19) United States
(12) Patent Application Publication
(10) Pub. No.: US 2025/0247893 A1
(43) Pub. Date: Jul. 31, 2025

(54) PRACH ADAPTATION FOR NETWORK ENERGY SAVING

(71) Applicant: Samsung Electronics Co., Ltd., Gyeonggi-do (KR)

(72) Inventors: Liang HU, San Diego, CA (US); Philippe Jean Marc Michel SARTORI, Naperville, IL (US)

(21) Appl. No.: 19/015,026

(22) Filed: Jan. 9, 2025

Related U.S. Application Data
(60) Provisional application No. 63/626,900, filed on Jan. 30, 2024.
(60) Provisional application No. 63/702,426, filed on Oct. 2, 2024.

(51) Int. Cl. H04W 74/0833; H04W 48/08

(52) U.S. Cl. CPC H04W 74/0833; H04W 48/08

(57) ABSTRACT

A system and a method are disclosed for reducing power consumption at a network level by utilizing PRACH frequency and time resource configurations for NES. A method performed by a terminal includes receiving, from a base station, first channel configuration information including a first PRACH configuration index and a PRACH mode indicator; receiving, from the base station, control information indicating a second PRACH configuration index corresponding to the first PRACH configuration index, based on the PRACH mode indicator; and performing PRACH transmissions at PRACH occasions, based on a PRACH configuration corresponding to the second PRACH configuration index. The second PRACH configuration index bundles the PRACH occasions in at least one of a time domain or a frequency domain.

### CROSS-REFERENCE TO RELATED APPLICATION

This application claims the priority benefit under 35 U.S.C. § 119(e) of U.S. Provisional Application Nos. 63/626,900 and 63/702,426, which were filed on Jan. 30, 2024, and Oct. 2, 2024, respectively, the disclosure of each of which is incorporated by reference in its entirety as if fully set forth herein.

### TECHNICAL FIELD

The disclosure generally relates to reducing power consumption at a network level. More particularly, the subject matter disclosed herein relates to improvements to physical random access channel (PRACH) frequency and time resource configurations for network energy saving (NES).

### SUMMARY

Through the development of cellular systems, a trend has been towards denser networks, larger operating bandwidths, and the use of a larger number of antennas. Consequently, power consumption of cellular networks has been constantly growing and is now making up a significant portion of system operating expenses.

While power consumption reductions for a user equipment (UE) have been standardized, until recently, there had been no discussion or work related to reducing power consumption at a network side. To remediate these types of issues, the 3rd generation partnership project (3GPP), in TR 38.864, v18.1, hereinafter, “Rel-18”, specified features for reducing power consumption at a network level.

More specifically, in accordance with Rel-18, it was stated that to increase a network's opportunities to go into a sleep mode, the number of frequent transmissions between two synchronization signal blocks (SSBs) should be reduced. Additionally, the number of periodic base station receptions such as physical uplink control channel (PUCCH) or PRACH occasions should be reduced. It is expected that reducing reception effort by a based station (e.g., a gNB) may bring considerable energy savings.

As a further work beyond Rel-18, an aspect of the present disclosure is to provide PRACH adaptation for network power saving techniques.

As it will be beneficial for NES as well as UE power consumption and latency, another aspect of the disclosure is to provide PRACH configuration enhancements with more light-weight mechanisms. For example, as a baseline, a gNB can be configured with an energy-optimized setting that is also followed by legacy UEs (e.g., Rel-18) and dynamically more resources can be made available for newer UEs, i.e., non-legacy UEs, e.g., through downlink control information (DCI). As a result, it is possible to dynamically adapt these resources without radio resource control (RRC) reconfigurations.

Accordingly, systems and methods are described herein for adapting PRACH frequency and time resource configurations for NES. Specifically, systems and methods are provided for time domain slot bundling, time domain symbol bundling, and frequency domain resource block (RB) bundling. More specifically, the energy savings techniques described herein allow PRACH occasions to be dynamically adapted on demand, instead of being configured at regular times.

In an embodiment, a method performed by a terminal in a communication system includes receiving, from a base station, first channel configuration information including a first PRACH configuration index and a PRACH mode indicator; receiving, from the base station, control information indicating a second PRACH configuration index corresponding to the first PRACH configuration index, based on the PRACH mode indicator; and performing PRACH transmissions at PRACH occasions, based on a PRACH configuration corresponding to the second PRACH configuration index. The second PRACH configuration index bundles the PRACH occasions in at least one of a time domain or a frequency domain.

In an embodiment, a terminal for use in a communication system includes a transceiver; and a processor configured to receive, from a base station, via the transceiver, first channel configuration information including a first PRACH configuration index and a PRACH mode indicator, receive, from the base station, via the transceiver, control information indicating a second PRACH configuration index corresponding to the first PRACH configuration index, based on the PRACH mode indicator, and perform PRACH transmissions, via the transceiver, at PRACH occasions, based on a PRACH configuration corresponding to the second PRACH configuration index. The second PRACH configuration index bundles the PRACH occasions in at least one of a time domain or a frequency domain.

In an embodiment, a method performed by a base station in a communication system includes transmitting, to a terminal, first channel configuration information including a first PRACH configuration index and a PRACH mode indicator; transmitting, to the terminal, control information indicating a second PRACH configuration index corresponding to the first PRACH configuration index, based on the PRACH mode indicator; and receiving, from the terminal, PRACH transmissions at PRACH occasions, based on a PRACH configuration corresponding to the second PRACH configuration index. The second PRACH configuration index bundles the PRACH occasions in at least one of a time domain or a frequency domain.

### BRIEF DESCRIPTION OF THE DRAWING

In the following section, the aspects of the subject matter disclosed herein will be described with reference to exemplary embodiments illustrated in the figures, in which:

FIG. 1 illustrates an example of a PRACH occasion configuration;

FIG. 2 illustrates an example of time domain slot-level RACH occasion (RO) bundling, according to an embodiment;

FIG. 3 is a flow chart illustrating UE operations when utilizing time domain slot-level RO bundling, according to an embodiment;

FIG. 4 illustrates an example of time domain symbol-level RO bundling, according to an embodiment;

FIG. 5 illustrates an example of frequency and time domain RB level RO bundling, according to an embodiment;

FIG. 6A is a flow chart illustrating a method performed by a UE according to an embodiment;

FIG. 6B is a flow chart illustrating a method performed by a base station according to an embodiment;

FIG. 7 is a block diagram of an electronic device in a network environment, according to an embodiment; and

FIG. 8 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

In accordance with the 3GPP Rel-19 Work Item on NES, embodiments of the present disclosure may specify adaptation of common signal/channel transmissions, and provide systems and methods for adaptation of PRACH in time domain.

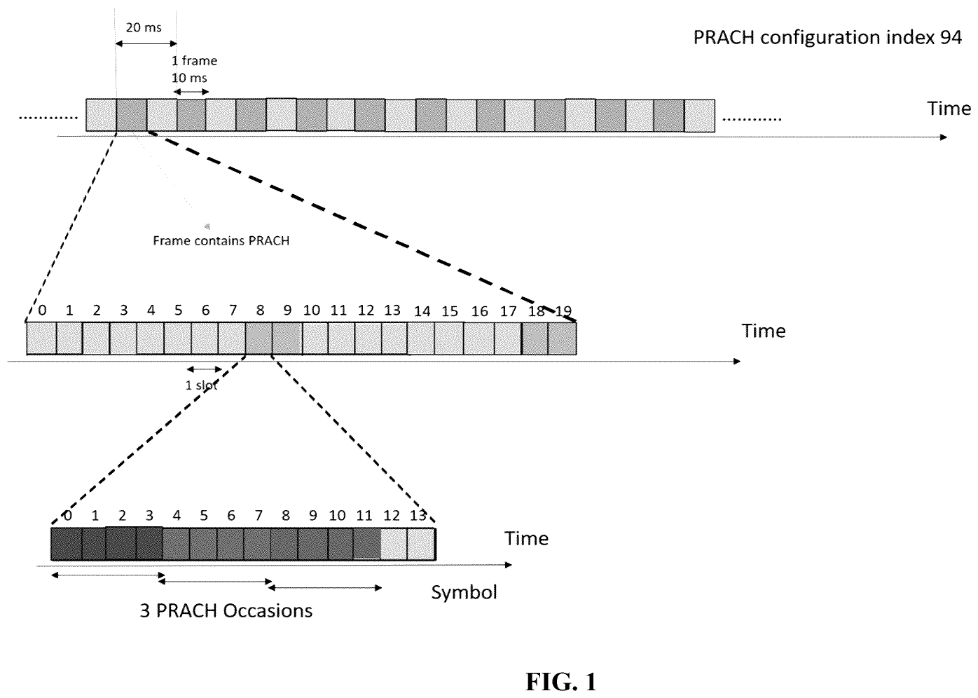

FIG. 1 illustrates an example of a PRACH occasion configuration in frequency range 1 (FR1) and unpaired spectrum. More specifically, FIG. 1 illustrates an example in which timings for PRACH occasions exist within subframes 4 and 9, e.g., as shown in Table 1 below.

TABLE 1

| | | | | | | | Nₜ^{RA, slot}, | |
|---|---|---|---|---|---|---|---|---|
| | | | | | | | number of | |
| | | | | | | Number of | time-domain | |
| | | | | | | PRACH | PRACH | |
| PRACH | | n_{f} mod | | | | slots | occasions | N_{dur}^{RA}, |
| Config | Preamble | x = y | | Subframe | Starting | within | within | PRACH |
| Index | format | x | y | number | symbol | subframe | PRACH slot | duration |
| 94 | A2 | 2 | 1 | 4, 9 | 0 | 2 | 3 | 4 |

Referring to FIG. 1, which corresponds to the PRACH configuration index 94 as shown in Table 1 above, this example is based on time division duplex (TDD), and therefore, relevant symbols within these subframes should be configured for the uplink.

In Table 1, the “Starting symbol” field indicates that PRACH occasions start at symbol “0”, while the “Number of PRACH slots within subframe” field indicates that 2 slots belonging to the subframe include PRACH occasions. This column is applicable because this example is based on 30 kHz subcarrier spacing SCS in which there are 2 slots per subframe.

The “Nₜ^{RA,slot}, number of time-domain PRACH occasions within PRACH slot” field indicates that 3 PRACH occasions are time multiplexed. The “N_{dur}^{RA}, PRACH duration” field indicates that each PRACH occasion occupies 4 symbols (preamble format A2). This example provides a total of 12-time multiplexed PRACH occasions per 20 ms.

Periodic receptions on PRACH occasions as illustrated in the example of FIG. 1 require a base station to be frequently (periodically) woken up, even when not needed, which wastes power.

Accordingly, systems and methods are described herein for adapting PRACH frequency and time resource configurations for NES. Specifically, systems and methods are provided for time domain slot bundling, time domain symbol bundling, and frequency domain RB bundling. The energy savings techniques described herein allow PRACH occasions to be dynamically adapted on demand, instead of being configured at regular times.

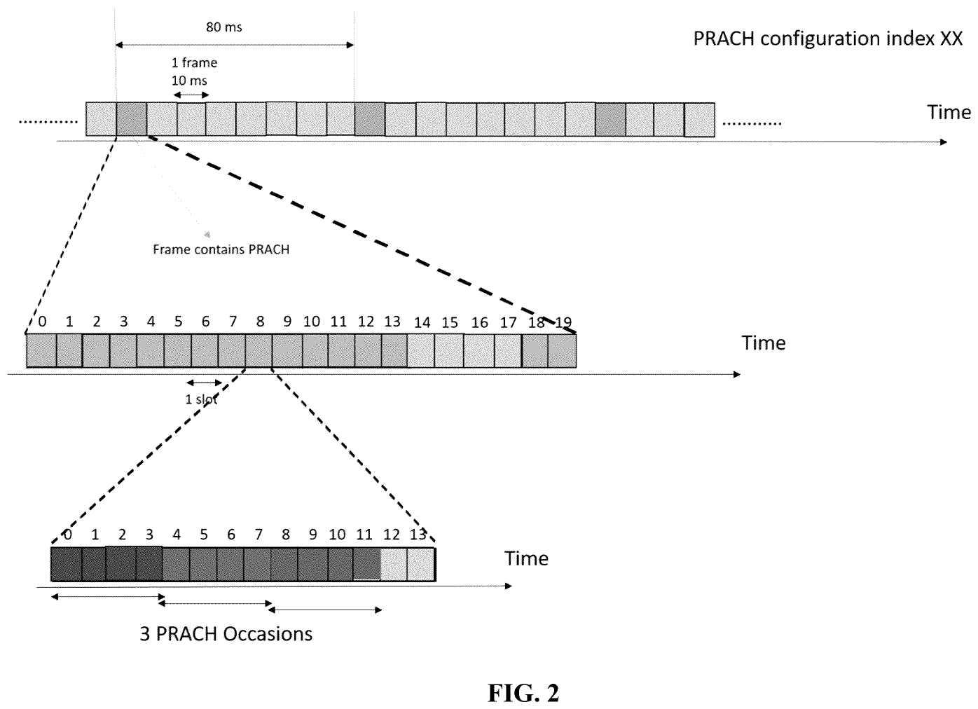

FIG. 2 illustrates an example of time domain slot-level RACH occasion (RO) bundling, according to an embodiment.

Additionally, the PRACH configuration of FIG. 2, i.e., PRACH configuration XX, is shown in Table 2 below.

TABLE 2

| | | | | | | | Nₜ^{RA, slot}, | |
|---|---|---|---|---|---|---|---|---|
| | | | | | | | number of | |
| | | | | | | Number of | time-domain | |
| | | | | | | PRACH | PRACH | |
| PRACH | | n_{f} mod | | | | slots | occasions | N_{dur}^{RA}, |
| Config | Preamble | x = y | | | Starting | within | within | PRACH |
| Index | format | x | y | Subframe number | symbol | subframe | PRACH slot | duration |
| XX | A2 | 8 | 1 | 0, 1, 2, 3, 4, 5, 6, 7, 10 | 0 | 2 | 3 | 4 |

Referring to FIG. 2, timing for PRACH occasions exist within slots {0-13, 18,19} or subframes {0,1,2,3,4,5,6,7, and 10}. The “starting symbol” field indicates that the PRACH occasions start at symbol “0”, and the “Number of PRACH slots within subframe” field indicates that both slots belonging to the subframe include PRACH occasions. As described above, because this example is based on 30 kHz SCS, there are 2 slots per subframe.

The “Nₜ^{RA,slot}, number of time-domain PRACH occasions within PRACH slot” field indicates that 3 PRACH occasions are time multiplexed. The “N_{dur}^{RA}, PRACH duration” field indicates that each PRACH occasion occupies 4 symbols (preamble format A2). This example provides a total of 48-time multiplexed PRACH occasions per 80 ms.

Compared to the PRACH configuration illustrated in FIG. 1 and Table 1, the PRACH resource density per time unit (i.e., PRACH occasions every 80 ms) is the same in FIG. 2, such that the system capacity for PRACH is maintained while the PRACH resources are more concentrated in time, i.e., within a single frame, instead of spreading over multiple frames in time. Therefore, the PRACH configuration illustrated in FIG. 2 and Table 2 provides an NES gain compared to the PRACH configuration illustrated in FIG. 1 and Table 1. For example, a gNB may be able to go into deep sleep state in between 2 PRACH frames as in FIG. 2.

To indicate the PRACH configuration illustrated in FIG. 2 and Table 2, a new information element (IE) “PRACH_mode” and a set of new PRACH configuration indexes may be provided in an RRC message as shown in bold below.

```
rach-ConfigCommon {
  rach-ConfigGeneric {
    PRACH_{—}mode {0, 1, 2, 3}
    prach-ConfigurationIndex XX,
    msg1-FDM one,
    msg1-FrequencyStart 0,
    zeroCorrelationZoneConfig 15,
    preambleReceivedTargetPower -110,
    preambleTransMax n7,
    powerRampingStep dB4,
    ra-ResponseWindow sl20
  },
  ssb-perRACH-OccasionAndCB-PreamblesPerSSB one: n8,
  ra-ContentionResolutionTimer sf64,
  prach-RootSequenceIndex l139: 1,
  msg1-SubcarrierSpacing kHz30,
  restrictedSetConfig unrestrictedSet
},
```

For example, PRACH mode 0 may indicate a legacy PRACH configuration for both legacy UEs and newer UEs, PRACH mode 1 may indicate a new PRACH configuration for newer UEs (e.g., time domain slot-level RO bundling), PRACH mode 2 may indicate a new PRACH configuration for newer UEs (e.g., time domain symbol-level RO bundling), and PRACH mode 3 may indicate a new PRACH configuration for newer UEs (e.g., frequency and time domain resource block level RO bunding).

Additionally, the New IEs “PRACH_mode” and/or “PRACH-configuration index” can be pre-configured to UEs via an RRC message in system information block 1 (SIB1) (within rach-ConfigCommon) and then dynamically indicated to UEs via UE specific DCI, group common DCI, or a medium access control (MAC) control element (CE). For example, the DCI may include DCI format 1_0 scrambled by a paging (P)-radio network temporary identifier (RNTI).

To provide backward compatibility, i.e., where newer UEs (e.g., rel-19) and legacy UEs are able to read a PRACH config index via the same SIB1 message), only a legacy PRACH index shall be indicated to both newer UEs and legacy UEs. A set of new PRACH indexes can be associated with (e.g., mapped to) a legacy PRACH index, where this association is pre-determined and pre-configured to the newer UEs via an RRC message. Thereafter, a newer UE first reads a legacy PRACH index, the same as a legacy UE, but a new PRACH index associated with the given legacy PRACH index can be dynamically indicated to the newer UE via DCI (group common or UE specific DCI) or a MAC CE. For example, an association rule may be that the set of subframes in the new PRACH configuration index should include the set of subframes in the associated legacy PRACH configuration index. In this way, backward compatibility may be maintained for legacy UEs to access the PRACH occasions.

A possible drawback of indicating via DCI is that a PRACH config index may occupy too many bits. Thus, according to an embodiment, other lower overhead indication methods may be utilized.

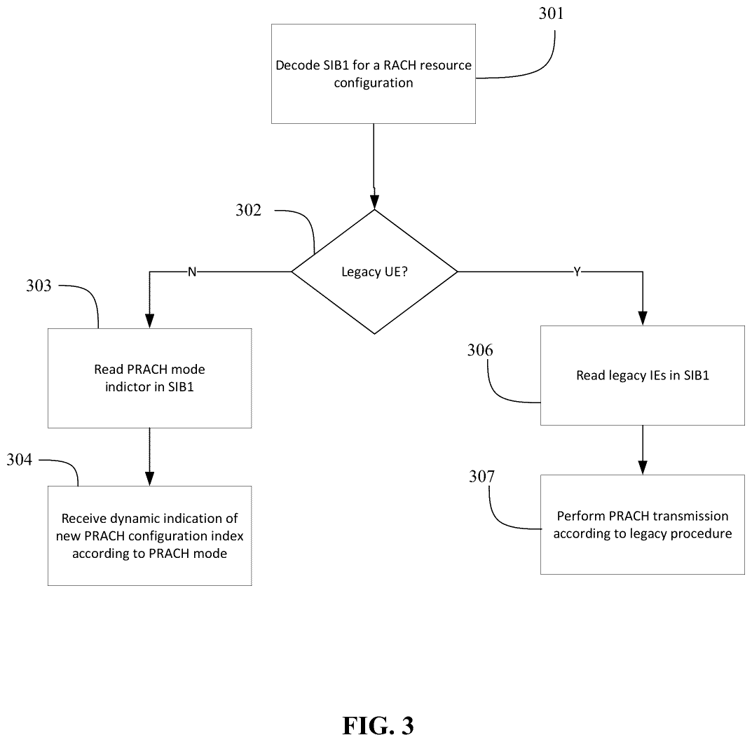

FIG. 3 is a flow chart illustrating UE operations when utilizing time domain slot-level RO bundling, according to an embodiment.

Referring to FIG. 3, in step 301, a UE decodes an SIB1 for a RACH resource configuration. Step 301 is performed commonly by both legacy UEs and newer UEs (e.g., Rel 19 UEs).

In step 302, the method of processing the decoded SIB1 is based on whether the UE is a legacy UE or a newer UE.

If the UE is not a legacy UE in step 302, i.e., is a newer UE, the UE reads a PRACH mode indicator in the SIB1 in step 303.

In step 304, the UE receives dynamic indication of a new PRACH configuration index according to the PRACH mode in the SIB1. For example, the new PRACH configuration index may be dynamically indicated to the newer UE via DCI (group common or UE specific DCI) or a MAC CE.

However, if the UE is a legacy UE in step 302, the UE reads the legacy IEs in the SIB1 in step 306, excluding the PRACH mode indicator. That is, the PRACH mode indicator is only read by newer UEs.

In step 307, the UE performs a PRACH transmission according to legacy procedures based on the read legacy IEs.

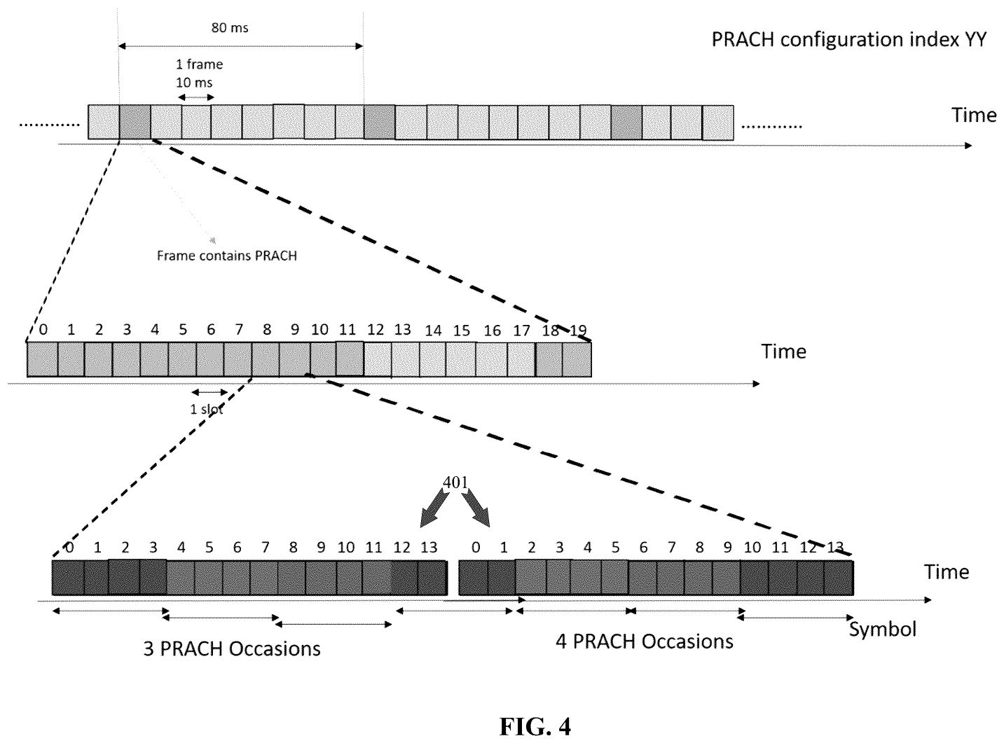

FIG. 4 illustrates an example of time domain symbol-level RO bundling, according to an embodiment.

Additionally, the PRACH configuration of FIG. 4, i.e., PRACH configuration YY, is shown in Table 3 below.

TABLE 3

| | | | | | | | Nₜ^{RA, slot}, | |
|---|---|---|---|---|---|---|---|---|
| | | | | | | | number of | |
| | | | | | | Number of | time-domain | |
| | | | | | | PRACH | PRACH | |
| PRACH | | n_{f} mod | | | | slots | occasions | N_{dur}^{RA}, |
| Config | Preamble | x = y | | Subframe | Starting | within | within a | PRACH |
| Index | format | x | y | number | symbol | subframe | PRACH slot | duration |
| YY | A2 | 8 | 1 | 0, 1, 2, 3, 4, 5, 10 | 0 | 2 | 3.5 | 4 |

One difference of time domain symbol-level RO bundling from time domain slot-level RACH occasion (RO) bundling is that a PRACH occasion can be defined based on time domain symbol level bounding, where a PRACH occasion may cross slot boundaries of two consecutive slots in time domain. In this case, the total PRACH occasions per period can be shorter than the case of time domain symbol-level RO bundling, and may provide additional NES gain, e.g., where a gNB can stay longer in a deep sleep mode.

Referring to FIG. 4 and Table 3, the timing for PRACH occasions exist within slots {0-11, 18, 19} or subframes {0,1,2,3,4,5 and 10}. The “Starting symbol” field indicates that the PRACH occasions start at symbol “0”, while the “Number of PRACH slots within subframe” field indicates that both slots belonging to the subframe include PRACH occasions. As described above, because the example is based on 30 kHz SCS, there are 2 slots per subframe.

The “Nₜ^{RA,slot}, number of time-domain PRACH occasions within PRACH slot” field indicates that 3.5 PRACH occasions are time multiplexed, where the 4th PRACH occasion 401 spans over two consecutive slots. The “N_{dur}^{RA}, PRACH duration” indicates that each PRACH occasion occupies 4 symbols (preamble format A2). This example provides a total of 48-time multiplexed PRACH occasions per 80 ms.

Compare to the PRACH configurations of FIGS. 1 and 2, the PRACH resource density per time unit (i.e., PRACH occasions every 80 ms) is the same in FIG. 4, such that the system capacity for PRACH is maintained while the PRACH resources are more concentrated in time i.e., in consecutive symbols across consecutive slots/subframes, instead of spreading over multiple frames or slots/frames in time, which brings additional NES gain.

To indicate the PRACH configuration illustrated in FIG. 4 and Table 3, a new IE “PRACH_mode” and a set of new PRACH configuration indexes may be provided in an RRC message as shown in bold below.

```
rach-ConfigCommon {
  rach-ConfigGeneric {
    PRACH_{—}mode {0, 1, 2, 3}
    prach-ConfigurationIndex YY,
    msg1-FDM one,
    msg1-FrequencyStart 0,
    zeroCorrelationZoneConfig 15,
    preambleReceivedTargetPower -110,
    preambleTransMax n7,
    powerRampingStep dB4,
    ra-Response Window sl20
  },
  ssb-perRACH-OccasionAndCB-PreamblesPerSSB one: n8,
  ra-ContentionResolutionTimer sf64,
  prach-RootSequenceIndex l139: 1,
  msg1-SubcarrierSpacing kHz30,
  restrictedSetConfig unrestrictedSet
},
```

The new IEs “PRACH_mode” and/or “prach-ConfigurationIndex” of FIG. 4 and Table 3 can be pre-configured to UEs via an RRC message in an SIB1 (within rach-ConfigCommon) and then dynamically indicated to a UE via UE specific DCI, group common DCI, or a MAC CE.

Similar to time domain slot-level RO bundling of FIG. 2, to ensure backward compatibility, i.e., the newer and legacy UEs are able to read the PRACH config index via the same SIB1 message, only the legacy PRACH index shall be indicated to both the newer and legacy UEs. A set of new PRACH indexes can be associated with (e.g., mapped to) a legacy PRACH index, where this association is pre-determined and pre-configured to a newer UE via an RRC message. Thereafter, the newer UE reads a legacy PRACH index, the same as legacy UE, and then identifies a new PRACH index associated with the given legacy PRACH index via a dynamic indication using DCI (group common or UE specific DCI) or a MAC CE. For example, an association rule may be is that the set of subframes and the set of symbols in those subframes in the new PRACH configuration index should include the set of subframes and the set of symbols of those subframes in the associated legacy PRACH configuration index. In this way, the backward compatibility may be maintained for legacy UEs to access the PRACH occasions.

Although not described again herein, UE operations when utilizing time domain symbol-level RO bundling may be the same as illustrated in FIG. 3.

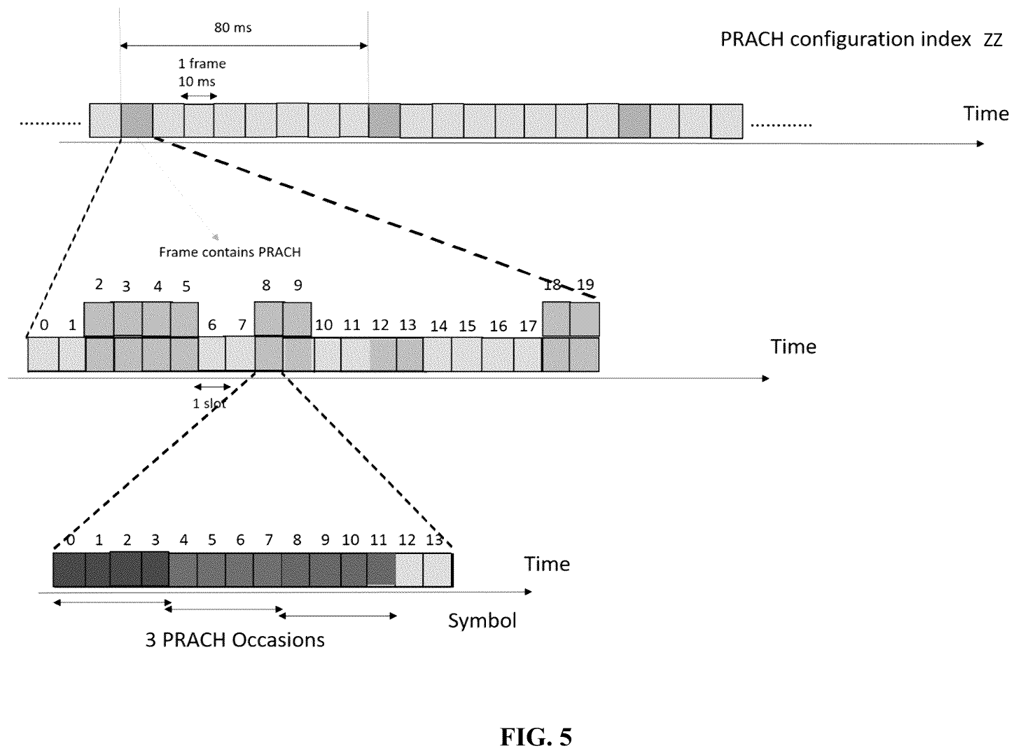

FIG. 5 illustrates an example of frequency and time domain RB level RO bundling, according to an embodiment.

Additionally, the PRACH configuration of FIG. 5, i.e., PRACH configuration ZZ, is shown in Table 4 below.

TABLE 4

| | | | | | | | Nₜ^{RA, slot}, | | | |
|---|---|---|---|---|---|---|---|---|---|---|
| | | | | | | | number of | | | |
| | | | | | | Number of | time-domain | | | |
| | | | | | | PRACH | PRACH | | | |
| PRACH | | n_{f} mod | | | | slots | occasions | N_{dur}^{RA}, | | |
| Config | Preamble | x = y | | Subframe | Starting | within | within | PRACH | msg1- | msg1- |
| Index | format | x | y | number | symbol | subframe | PRACH slot | duration | FDM | FrequencyStart |
| ZZ | A2 | 8 | 1 | 0, 2, 4, 6, 10 | 0 | 2 | 3 | 4 | 2 | 0 |

One difference of frequency and time domain RB level RO bundling from time domain slot-level RO bundling and time domain symbol-level RO bundling in FIGS. 2 and 4, respectively, is that a PRACH occasion can be defined based on both frequency domain RB bounding where a PRACH occasion may occupy in a same time domain resource as legacy PRACH occasions, and occupy a different frequency domain resource. In this case, the total PRACH occasions per period can be further squeezed in time domain than in time domain slot-level RO bundling and time domain symbol-level RO bundling in FIGS. 2 and 4, respectively. This may provide additional NES gain, e.g., when a gNB can stay in a deep sleep mode even longer.

Referring to FIG. 5 and Table 4, the timing for PRACH occasions exist within slots {2, 3, 4, 5, 8, 9, 12, 13, 18, and 19} or subframes {1, 2, 4, 6, and 10}. The “starting symbol” field indicates that the PRACH occasions start at symbol “0”, while the “Number of PRACH slots within subframe” field indicates that both slots belonging to the subframe include PRACH occasions. As described above, because this example is based on 30 kHz SCS, there are 2 slots per subframe.

The “Nₜ^{RA,slot}, number of time-domain PRACH occasions within PRACH slot” field indicates that 3 PRACH occasions are time multiplexed. The “N_{dur}^{RA}, PRACH duration” field indicates that each PRACH occasion occupies 4 symbols (preamble format A2).

In frequency domain, the “msg1-FDM” field indicates 2. If the “msg1-FDM” field, which has possible values of 1, 2, 4, or 8, in RACH-ConfigGeneric>1, this indicates that there will be multiple PRACH occasions in one time instance, multiplexed in the frequency domain.

Additionally, the “msg1-FrequencyStart” field indicates 0. The “msg1-FrequencyStart” field indicates an offset of a lowest PRACH transmission occasion in the frequency domain with respect to a physical resource block (PRB) 0. The value may be configured so that a corresponding RACH resource is entirely within a bandwidth of an uplink bandwidth part (BWP).

In the example of FIG. 5, a total of 48-time multiplexed PRACH occasions are provided per 80 ms. Compare to the PRACH configurations of FIGS. 1, 2, and 4, the PRACH resource density per time unit (i.e., PRACH occasions every 80 ms) is the same in FIG. 4, such that the system capacity for PRACH is maintained while the PRACH resources are even more concentrated in time.

To indicate the PRACH configuration illustrated in FIG. 5 and Table 4, a new IE “PRACH_mode” and a set of new PRACH configuration indexes may be provided in an RRC message as shown in bold below.

```
rach-ConfigCommon {
  rach-ConfigGeneric {
    PRACH_{—}mode {0, 1, 2, 3}
    prach-ConfigurationIndex ZZ,
    msg1-FDM 1,
    msg1-FrequencyStart 0,
    zeroCorrelationZoneConfig 15,
    preambleReceivedTargetPower -110,
    preambleTransMax n7,
    powerRampingStep dB4,
    ra-ResponseWindow sl20
  },
  ssb-perRACH-OccasionAndCB-PreamblesPerSSB one: n8,
  ra-ContentionResolutionTimer sf64,
  prach-RootSequenceIndex l139: 1,
  msg1-SubcarrierSpacing kHz30,
  restrictedSetConfig unrestrictedSet
},
```

The new IEs “PRACH_mode” and/or “prach-ConfigurationIndex” of FIG. 5 can be pre-configured to UEs via an RRC message in an SIB1 (within rach-ConfigCommon) and then dynamically indicated to a UE via UE specific DCI, group common DCI, or a MAC CE.

Similar to FIG. 2 and FIG. 4, to ensure backward compatibility, i.e., where newer UEs9 and legacy UEs are able to read the PRACH config index via the same SIB1 message, only the legacy PRACH index shall be indicated to both newer and legacy UEs. A set of new PRACH indexes can be associated with (e.g., mapped to) a legacy PRACH index, where the association is pre-determined and pre-configured to a newer UE via an RRC message. Thereafter, the newer UE first reads a legacy PRACH index, the same as a legacy UE, and then a new PRACH index of FIG. 5, which is associated with the legacy PRACH index, can be dynamically indicated to the newer UE via DCI (group common or UE specific DCI) or a MAC CE.

For example, the association rule may be that the set of subframes and the set of symbols in those subframes in the new PRACH configuration index should include the set of subframes and the set of symbols of those subframes in the associated legacy PRACH configuration index. In addition, the set of frequency domain RBs in the new PRACH configuration index should include the set of frequency domain RBs in the associated legacy PRACH configuration index. In this way, the backward compatibility is maintained for legacy UEs to access the PRACH occasions.

Although not described again herein, UE operations when utilizing frequency and time domain RB level RO bundling may be the same as illustrated in FIG. 3.

After identifying both time and frequency domain multiplexing, a UE knows a total number of PRACH occasions within a PRACH configuration period. Then, each PRACH occasion should be linked to a specific SSB beam.

A UE may identify an “Association Period” as a minimum number of PRACH configuration periods that include sufficient PRACH occasions to allow every SSB beam to be mapped onto a set of the PRACH occasions at least once. The number of PRACH configuration periods that can belong to an association period may depend on the PRACH configuration period. For example, with an enhanced PRACH occasion configuration, e.g., time domain slot-level RO bundling, as illustrated in FIG. 2, an SSB to PRACH mapping table can be defined as shown in Table 5 below.

TABLE 5

| PRACH Configuration Period | | Association Period |
|---|---|---|
| 10 | ms | {1, 2} PRACH configuration periods |
| 20 | ms | {1, 2} PRACH configuration periods |
| 40 | ms | {1, 2} PRACH configuration periods |
| 80 | ms | {1, 2} PRACH configuration periods |
| 160 | ms | {1} PRACH configuration periods |

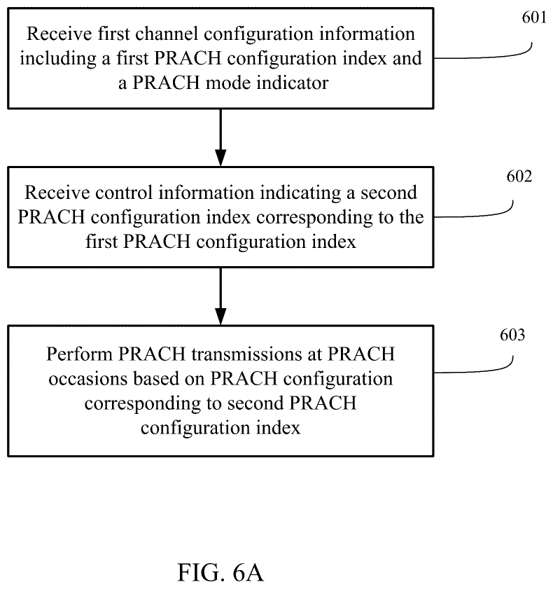

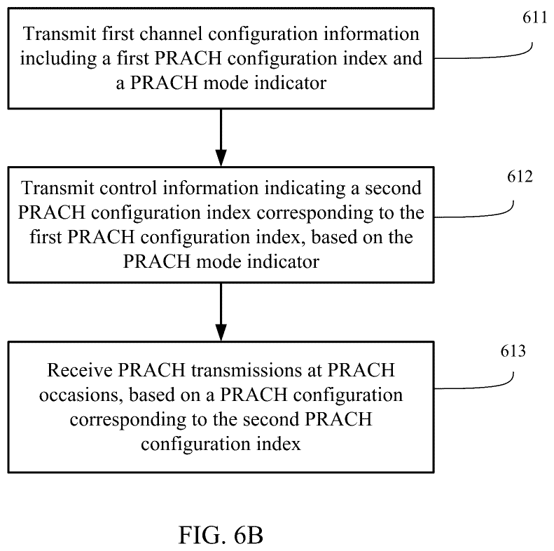

FIG. 6A is a flow chart illustrating a method performed by a UE according to an embodiment.

Referring to FIG. 6A, in step 601, the UE receives, from a base station, first channel configuration information including a first PRACH configuration index and a PRACH mode indicator.

In step 602, the UE receives, from the base station, control information indicating a second PRACH configuration index corresponding to the first PRACH configuration index, based on the PRACH mode indicator. The second PRACH configuration index may indicate a first PRACH resource for a legacy UE and a second PRACH resource for a non-legacy UE.

In step 603, the UE performs PRACH transmissions at PRACH occasions, based on a PRACH configuration corresponding to the second PRACH configuration index. As described above, the second PRACH configuration index may bundle the PRACH occasions in time domain and/or frequency domain.

FIG. 6B is a flow chart illustrating a method performed by a base station according to an embodiment.

Referring to FIG. 6B, in step 611, the base station transmits, to a terminal, e.g., a UE, first channel configuration information including a first PRACH configuration index and a PRACH mode indicator.

In step 612, the base station transmits, to the terminal, control information indicating a second PRACH configuration index corresponding to the first PRACH configuration index, based on the PRACH mode indicator. The second PRACH configuration index may indicate a first PRACH resource for a legacy UE and a second PRACH resource for a non-legacy UE.

In step 613, the base station receives, from the terminal, PRACH transmissions at PRACH occasions, based on a PRACH configuration corresponding to the second PRACH configuration index. As described above, the second PRACH configuration index may bundle the PRACH occasions in time domain and/or frequency domain.

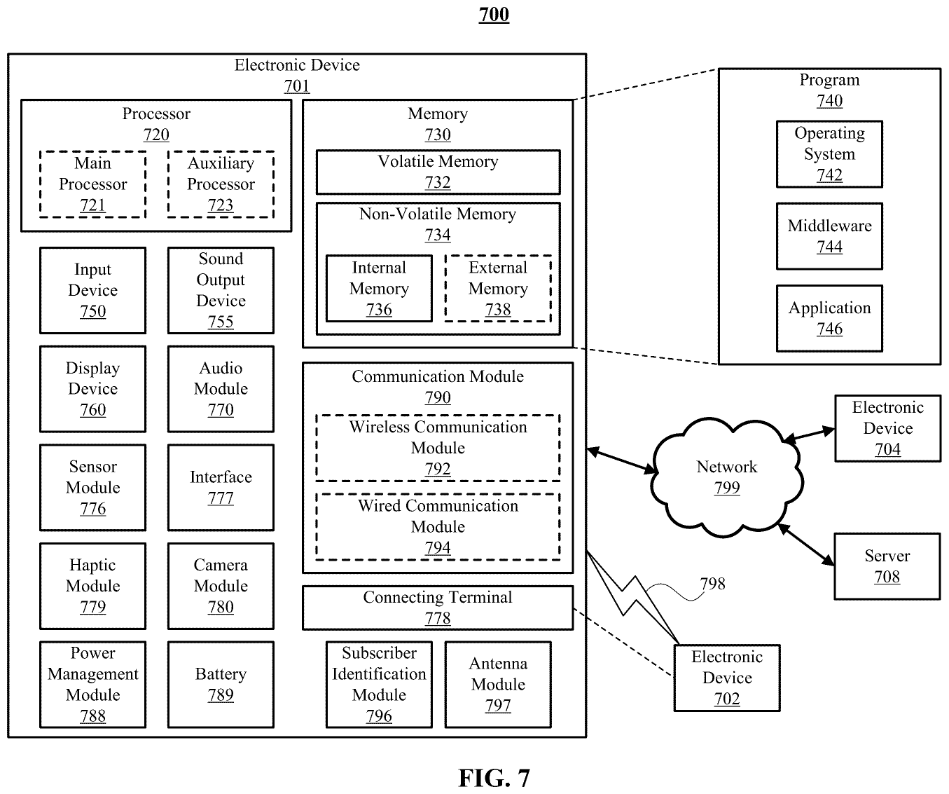

FIG. 7 is a block diagram of an electronic device in a network environment 700, according to an embodiment.

Referring to FIG. 7, an electronic device 701 in a network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720, a memory 730, an input device 750, a sound output device 755, a display device 760, an audio module 770, a sensor module 776, an interface 777, a haptic module 779, a camera module 780, a power management module 788, a battery 789, a communication module 790, a subscriber identification module (SIM) card 796, or an antenna module 797. In one embodiment, at least one (e.g., the display device 760 or the camera module 780) of the components may be omitted from the electronic device 701, or one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled with the processor 720 and may perform various data processing or computations, e.g., the method illustrated in FIG. 3 or 6A.

As at least part of the data processing or computations, the processor 720 may load a command or data received from another component (e.g., the sensor module 776 or the communication module 790) in volatile memory 732, process the command or the data stored in the volatile memory 732, and store resulting data in non-volatile memory 734. The processor 720 may include a main processor 721 (e.g., a central processing unit (CPU) or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734. Non-volatile memory 734 may include internal memory 736 and/or external memory 738.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. The display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. The audio module 770 may obtain the sound via the input device 750 or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device 702 directly (e.g., wired) or wirelessly. The interface 777 may include, for example, a high-definition multimedia interface (HDMI), a universal serial bus (USB) interface, a secure digital (SD) card interface, or an audio interface.

A connecting terminal 778 may include a connector via which the electronic device 701 may be physically connected with the external electronic device 702. The connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. The haptic module 779 may include, for example, a motor, a piezoelectric element, or an electrical stimulator.

The camera module 780 may capture a still image or moving images. The camera module 780 may include one or more lenses, image sensors, image signal processors, or flashes. The power management module 788 may manage power supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication. The communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as BLUETOOTH™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. The antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

Commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

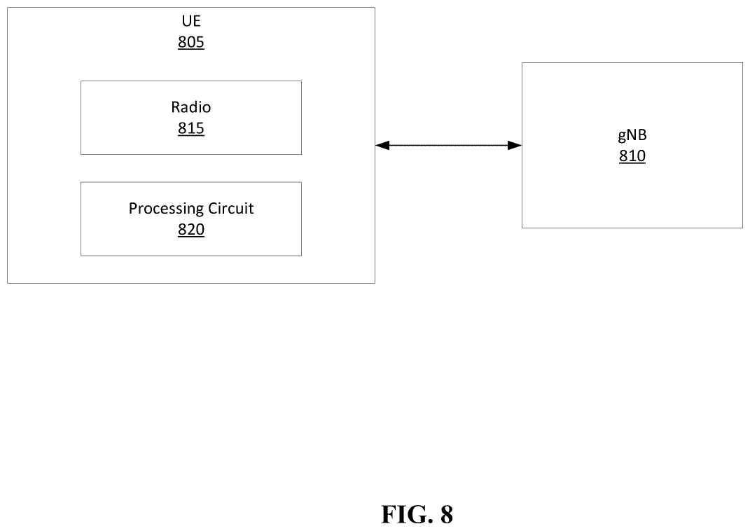

FIG. 8 shows a system including a UE 805 and a gNB 810, in communication with each other. The UE may include a radio 815 and a processing circuit (or a means for processing) 820, which may perform various methods disclosed herein, e.g., the method illustrated in FIG. 3 or 6A. For example, the processing circuit 820 may receive, via the radio 815, transmissions from the network node (gNB) 810, and the processing circuit 820 may transmit, via the radio 815, signals to the gNB 810.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by a terminal in a communication system, the method comprising:
receiving, from a base station, first channel configuration information including a first physical random access channel (PRACH) configuration index and a PRACH mode indicator;
receiving, from the base station, control information indicating a second PRACH configuration index corresponding to the first PRACH configuration index, based on the PRACH mode indicator; and
performing PRACH transmissions at PRACH occasions, based on a PRACH configuration corresponding to the second PRACH configuration index,
wherein the second PRACH configuration index bundles the PRACH occasions in at least one of a time domain or a frequency domain.

2. The method of claim 1, wherein the second PRACH configuration index indicates a first PRACH resource for a legacy user equipment (UE) and a second PRACH resource for a non-legacy UE.

3. The method of claim 2, wherein the PRACH configuration bundles the PRACH occasions in three or more consecutive slots within one frame of a random access channel (RACH) period of the second PRACH resource.

4. The method of claim 2, wherein the PRACH configuration bundles the PRACH occasions in two or more consecutive symbols of the second PRACH resource.

5. The method of claim 4, wherein a PRACH occasion among the PRACH occasions crosses slot boundaries of a two consecutive slots included in the two or more consecutive symbols.

6. The method of claim 2, wherein the PRACH configuration bundles the PRACH occasions in two or more contiguous frequency and time domain resource blocks (RBs) of the second PRACH resource.

7. The method of claim 1, further comprising identifying a minimum number of PRACH configuration periods that include sufficient PRACH occasions for each synchronization signal block (SSB) beam to be mapped onto a set of the PRACH occasions at least once.

8. The method of claim 1, wherein the first channel configuration information includes a system information block (SIB) indicating a PRACH mode.

9. The method of claim 1, wherein the control information includes downlink control information (DCI) or a medium access control (MAC) control element (CE).

10. The method of claim 9, wherein the DCI includes DCI format 1_0 scrambled by a paging (P)-radio network temporary identifier (RNTI).

11. A terminal for use in a communication system, the terminal comprising:
a transceiver; and
a processor configured to:
receive, from a base station, via the transceiver, first channel configuration information including a first physical random access channel (PRACH) configuration index and a PRACH mode indicator,
receive, from the base station, via the transceiver, control information indicating a second PRACH configuration index corresponding to the first PRACH configuration index, based on the PRACH mode indicator, and
perform PRACH transmissions, via the transceiver, at PRACH occasions, based on a PRACH configuration corresponding to the second PRACH configuration index,
wherein the second PRACH configuration index bundles the PRACH occasions in at least one of a time domain or a frequency domain.

12. The terminal of claim 11, wherein the second PRACH configuration index indicates a first PRACH resource for a legacy user equipment (UE) and a second PRACH resource for a non-legacy UE.

13. The terminal of claim 12, wherein the PRACH configuration bundles the PRACH occasions in three or more consecutive slots within one frame of a random access channel (RACH) period of the second PRACH resource.

14. The terminal of claim 12, wherein the PRACH configuration bundles the PRACH occasions in two or more consecutive symbols of the second PRACH resource.

15. The terminal of claim 14, wherein a PRACH occasion among the PRACH occasions crosses slot boundaries of a two consecutive slots included in the two or more consecutive symbols.

16. The terminal of claim 9, wherein the PRACH configuration bundles the PRACH occasions in two or more contiguous frequency and time domain resource blocks (RBs) of the second PRACH resource.

17. The terminal of claim 9, wherein the processor is further configured to identify a minimum number of PRACH configuration periods that include sufficient PRACH occasions for each synchronization signal block (SSB) beam to be mapped onto a set of the PRACH occasions at least once.

18. The terminal of claim 9, wherein the first channel configuration information includes a system information block (SIB) indicating a PRACH mode.

19. The terminal of claim 9, wherein the control information includes downlink control information (DCI) or a medium access control (MAC) control element (CE).

20. A method performed by a base station in a communication system, the method comprising:
transmitting, to a terminal, first channel configuration information including a first physical random access channel (PRACH) configuration index and a PRACH mode indicator;
transmitting, to the terminal, control information indicating a second PRACH configuration index corresponding to the first PRACH configuration index, based on the PRACH mode indicator; and
receiving, from the terminal, PRACH transmissions at PRACH occasions, based on a PRACH configuration corresponding to the second PRACH configuration index,
wherein the second PRACH configuration index bundles the PRACH occasions in at least one of a time domain or a frequency domain.
